(19) United States
(12) Patent Application Publication
(10) Pub. No.: US 2012/0075663 A1
(43) Pub. Date: Mar. 29, 2012

(54) PROVIDING IMAGE INFORMATION TO A REMOTE DEVICE

(75) Inventors: Joey P. Lum, Irvine, CA (US); Henry Y. Fang, Cerritos, CA (US)

(73) Assignee: Sharp Laboratories of America, Inc., Camas, WA (US)

(21) Appl. No.: 12/893,909

(22) Filed: Sep. 29, 2010

(51) Int. Cl. G06F 3/12

(52) U.S. Cl. 358/1.15

(57) ABSTRACT

An imaging device configured to provide image information to a remote device is described. The imaging device includes a processor and instructions stored in memory. The imaging device obtains a full image and generates a thumbnail image based on the full image. The imaging device also associates the full image with the thumbnail image using an index value and stores the full image and the thumbnail image on the imaging device.

### TECHNICAL FIELD

The present disclosure relates generally to electronic systems. More specifically, the present disclosure relates to providing image information to a remote device.

### BACKGROUND

The use of electronic devices has become commonplace in modern society. Many people use electronic devices as part of their work routine and for personal use at home. Electronic devices that are commonly used include computing devices, such as personal computers or laptops. Imaging devices are also commonly used.

Networks that allow several electronic devices to communicate with each other are also commonly used. For example, many computers and/or servers may be connected to a network, allowing the computers and/or servers to communicate with each other. Other electronic devices such as multifunction peripherals may also be directly or indirectly connected to a network. Thus, computing devices and electronic devices may communicate with each other using a network.

When computing and/or electronic devices communicate with each other using network resources, those resources (e.g., bandwidth) may become scarce. This may be particularly true as more computing and/or electronic devices use the network or send large amounts of data across the network. When the network handles a large amount of traffic, it may not operate as efficiently or quickly as when the amount of traffic is low to moderate. As can be seen from this discussion, systems and methods that reduce the amount of network traffic between computing and/or electronic devices may be beneficial.

### BRIEF DESCRIPTION OF THE DRAWINGS

FIG. 1 is a block diagram illustrating one configuration of an imaging device and a computing device in which systems and methods for providing image information to a remote device may be implemented;

FIG. 2 is a flow diagram illustrating one configuration of a method for providing image information to a remote device;

FIG. 3 is a block diagram illustrating one configuration of a method for remotely coordinating imaging device operations;

FIG. 4 is a block diagram illustrating a more specific configuration of an imaging device and a computing device wherein systems and methods for providing image information to a remote device may be implemented;

FIG. 5 is a flow diagram illustrating a more specific configuration of a method for providing image information to a remote device;

FIG. 6 is a block diagram illustrating one example of one configuration of a multifunction peripheral (MFP) device and an application server in which systems and methods for providing image information to a remote device may be implemented;

FIG. 7 is a flow diagram illustrating one configuration of a method for providing image information to a remote device;

FIG. 8 is a diagram illustrating pipelined operation for the systems and methods disclosed herein;

FIG. 9 is a block diagram illustrating several configurations of a network in which systems and methods for providing image information to a remote device may be implemented; and

FIG. 10 is a block diagram illustrating hardware components that may be used in accordance with the systems and methods disclosed herein.

### DETAILED DESCRIPTION

An imaging device configured to provide image information to a remote device is disclosed. The imaging device includes a processor and instructions stored in memory. The imaging device obtains a full image and generates a thumbnail image based on the full image. The imaging device also associates the full image with the thumbnail image using an index value and stores the full image and the thumbnail image on the imaging device.

The imaging device may further include a scanner. Obtaining a full image may include scanning. The imaging device may also send the full image only after receiving an approval. The imaging device may also send the full image only once after receiving an approval. The imaging device may further send the index value. The index value may be sent without the full image and without the thumbnail image.

The imaging device may also generate an event based on the index value, send the event and receive a form including the index value. The imaging device may also retrieve the thumbnail image using the index value and display the thumbnail image.

The imaging device may further modify the full image while the thumbnail image is being displayed. The imaging device may operate according to pipelined operations or batched operations.

A computing device configured for remotely coordinating image device operations is also disclosed. The computing device includes a processor and instructions stored in memory. The computing device receives an event including an index value, generates a form based on the index value and sends the form. The computing device also receives a full image. The computing device may also store the full image. The form may be used by an imaging device to display one or more thumbnail images.

A method to provide image information to a remote device is also disclosed. The method includes obtaining a full image and generating a thumbnail image based on the full image on an imaging device. The method also includes associating the full image with the thumbnail image using an index value and storing the full image and the thumbnail image on the imaging device.

A method for remotely coordinating image device operations is also disclosed. The method includes receiving an event including an index value and generating a form based on the index value by a computing device. The method also includes sending the form and receiving a full image.

A non-transitory tangible computer-readable medium for providing image information to a remote device is also disclosed. The computer-readable medium includes executable instructions for obtaining a full image and generating a thumbnail image based on the full image. The computer-readable medium also includes executable instructions for associating the full image with the thumbnail image using an index value and storing the full image and the thumbnail image.

A non-transitory tangible computer-readable medium for remotely coordinating image device operations is also disclosed. The computer-readable medium includes executable instructions for receiving an event including an index value and generating a form based on the index value. The computer-readable medium also includes executable instructions for sending the form and receiving a full image.

The systems and methods disclosed herein relate to the area of a remote application interface to an imaging device and workflow management processing. The systems and methods disclosed herein may use technologies such as web services, Extensible Markup Language (XML) and image processing and database management. The systems and methods herein may be used to enable remote applications to efficiently display thumbnail images without consuming large amounts of network bandwidth and to reduce the amount of overall processing required by a remote application.

Electronic images and/or documents may be used in many applications. One useful feature of an imaging device (e.g., scanner, multi-function peripheral (MFP)) may be an image send feature. The image send feature may be an enabling technology for creating electronic images and/or documents and for creating business workflows that result in their usage. One useful aspect of using electronic images and/or documents is allowing a user to review and/or modify these images and/or documents at the front panel of the imaging device while they are being displayed. One way to display captured (e.g., scanned) images is by using thumbnail representations of the captured image.

Thumbnail presentation of the captured images may extend imaging device usability with a series of features such as image rotation, image correction and adjustment and image annotation. These operations may be performed in real time as images are being captured (e.g., pages are being scanned) at the front panel of the imaging device.

The systems and methods disclosed herein may enable a remote application (e.g., an application on a computing device that is connected via a network to the imaging device) to efficiently access stored thumbnails as part of a workflow application. This may occur, for example, while a user is at the imaging device. Additionally, during the presentation of the thumbnails, the image may be rotated, adjusted or annotated as represented by the thumbnail. One beneficial aspect of the systems and methods disclosed herein is that the captured images and/or thumbnails may be generated in the imaging device. For example, the imaging device generates (e.g., renders) the thumbnails based on the captured images. The thumbnails may be stored in memory on the imaging device.

The display of the thumbnails may be triggered by one or more index values received from the remote application, causing the imaging device to display the thumbnails on the imaging device front panel. According to the systems and methods disclosed herein, the amount of network traffic typically used for such operations may be reduced, thereby improving efficiency. Corrections, adjustments, modifications and/or one or more reviews may also be performed at the imaging device. Once the corrections, adjustments, modifications and/or one or more reviews or approvals are completed, the captured images may be sent using a network to a computing device (e.g., by using File Transfer Protocol (FTP), email, etc.). The remote application may not be involved in the image processing, but may coordinate the activities.

The thumbnail data may be made available for access immediately after an image is obtained or captured. Furthermore, the thumbnail object may be referenced in Hypertext Markup Language (HTML) as an attribute in an <img/> HTML tag. Additionally, the imaging device may receive and respond to messages from the remote computing device (e.g., application server) to allow access to the thumbnail objects using job control information made available to the remote application by the imaging device.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

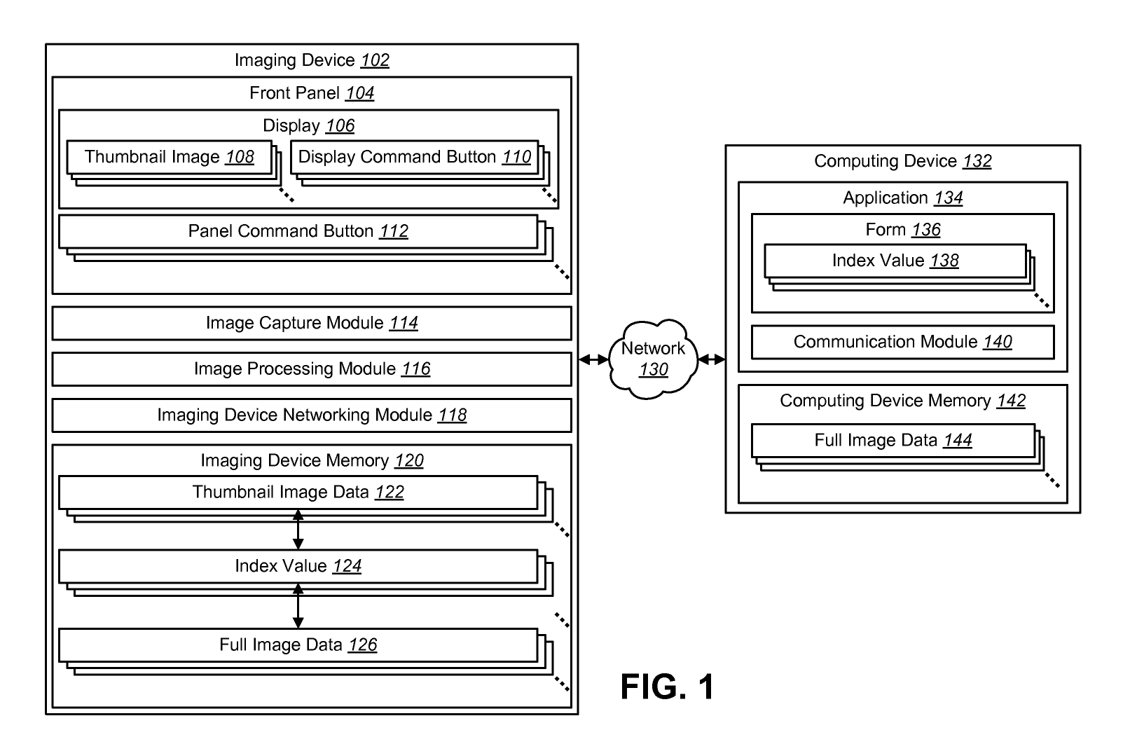

FIG. 1 is a block diagram illustrating one configuration of an imaging device 102 and a computing device 132 in which systems and methods for providing image information to a remote device may be implemented. An imaging device 102 and a computing device 132 may be connected to and communicate with each other using a network 130. The imaging device 102 may include a front panel 104, an image capture module 114, an image processing module 116, an imaging device networking module 118 and/or imaging device memory 120.

The front panel 104 may be a module attached to or integrated into the imaging device 102. The front panel 104 may include a display 106. One or more panel command buttons 112 may also be included on the front panel 104. The display 106 may display one or more thumbnail images 108 and/or one or more display command buttons 110. The display 106 may use any suitable display technology (e.g., Liquid Crystal Display (LCD), Organic Light Emitting Diode (OLED), Cathode Ray Tube (CRT), etc.). The display 106 may optionally be a touch panel. In this way, the display command button or buttons 110 may receive input from a user.

The image capture module 114 may be a hardware and/or software module that may be used to capture images. For example, the image capture module 114 may include a scanner, digital camera or other module used to capture images. The imaging device networking module 118 may be a hardware and/or software module that may be used to format data for transmission over the network 130.

The imaging device memory 120 may comprise one or more devices used to store data. For example, the imaging device memory 120 may comprise Random Access Memory (RAM), Read-Only Memory (ROM), Electrically Erasable Programmable Read-Only Memory (EEPROM), some other type of memory or a combination of different types of memory. The imaging device memory 120 may be implemented as a magnetic disk, integrated circuit or semiconductor chip, some other electronic device for storing electronic data or a combination thereof. The imaging device memory 120 may include thumbnail image data 122 (e.g., one or more thumbnail image files), one or more index values 124 and/or full image data 126 (e.g., one or more full image files).

The computing device 132 may include an application 134 and computing device memory 142. The application 134 may include a communication module 140. The communication module 140 may format data for transmission across the network 130. The application 134 may generate one or more forms 136, each including one or more index values 138. The computing device memory 142 may be implemented as one or more types of electronic data storage. The computing device memory 142 may store full image data 144 (e.g., one or more full image files). Full image data 126, 144 may refer to image data that is obtained at a desired resolution and/or with full dimensions, for example. Thumbnail image data 122 may refer to image data that reflects the contents of full image data 126, but with comparatively smaller dimensions and/or perhaps a lower resolution.

The image capture module 114 may be used to obtain an electronic image. In one configuration, the image capture module 114 includes a scanner that may be used to scan a document. The image obtained by the image capture module 114 may be stored in the imaging device memory 120 as full image data 126. The image processing module 116 may generate thumbnail image data 122 based on full image data 126, which may be stored in the imaging device memory 120. The imaging device 102 may generate an index value 124 corresponding to the full image data 126 that links the thumbnail image data 122 to the full image data 126. The index value 124 may be sent to the computing device 132 using the imaging device networking module 118. The application 134 on the computing device 132 may use the index value 138 to generate the form 136. The form 136 may be sent to the imaging device 102 across the network 130. The imaging device 102 may use the received form 136 (including the index value 138) to retrieve thumbnail image data 122 from the imaging device memory 120. The retrieved thumbnail image data 122 may be used to display a thumbnail image 108 on the display 106.

While displaying the thumbnail image 108 on the display 106, the imaging device 102 may receive commands from the command buttons 110, 112 indicating commands to modify the full image data 126 and/or approve the full image data 126 as represented by the thumbnail images 108. Once the images 126 are approved and/or modified, the imaging device 102 may send the full image data 126 to the computing device 132 using the network 130. The computing device 132 may receive and store the full image data 144 in computing device memory 142. Other computing devices (e.g., personal computers, laptop computers, smart phones, etc.) may be connected to the network 130. The computing device 132 may provide access to the full image data 144 for the other computing devices (not shown) connected to the network 130. For example, another computing device connected to the network 130 may view and/or download the full image data 144 stored in computing device memory 142.

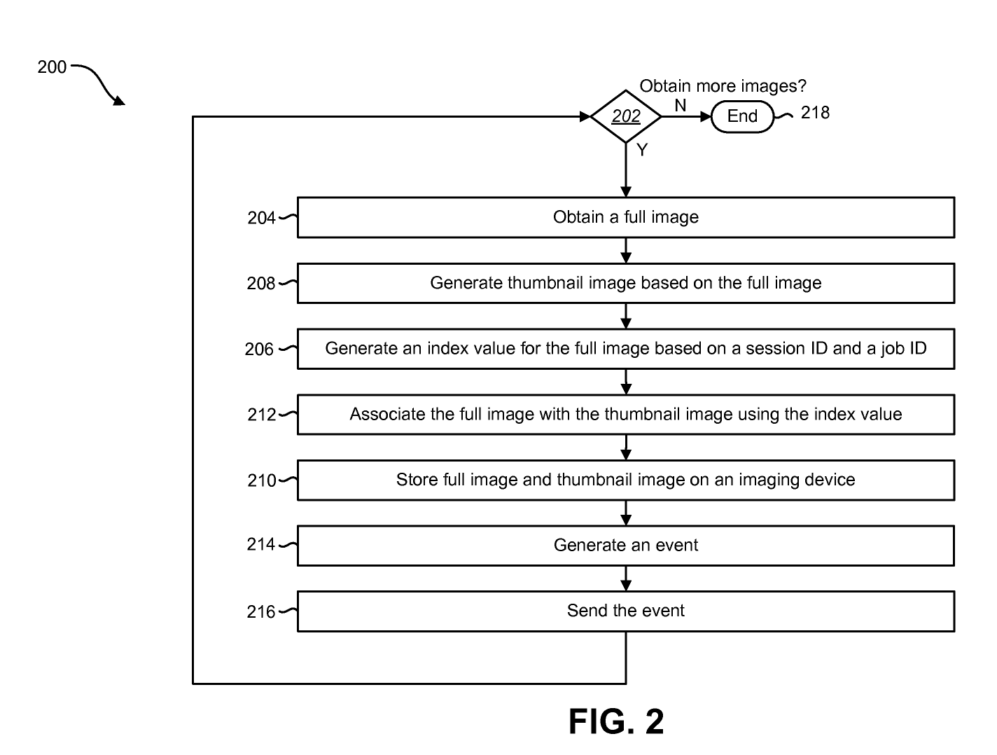

FIG. 2 is a flow diagram illustrating one configuration of a method 200 for providing image information to a remote device. The imaging device 102 may determine 202 whether to obtain one or more images. For example, the imaging device 102 may receive a request to scan a document or image. Furthermore, the imaging device 102 may use a sensor to determine if one or more pages remain for scanning. If the imaging device 102 determines 202 to obtain one or more additional images, the imaging device 102 may obtain 204 full image data 126 (e.g., by scanning a page of a document). The imaging device 102 may generate 208 thumbnail image data 122 based on the full image data 126. For example, the imaging device 102 may compress the full image data 126 and/or scale down the full image data 126 dimensions to generate 208 the thumbnail image data 122. The imaging device 102 may also generate 206 an index value 124 for the full image data 126. The index value 124 may be generated 206 based on a session identifier or identification (ID) and/or on a job ID. The index value 124 may indicate one or more addresses where the full image data 126 and its corresponding thumbnail image data 122 may be stored. The imaging device 102 may then associate 212 the full image data 126 with the thumbnail image data 122 using the index value 124. The imaging device 102 may store 210 the full image data 126 and the thumbnail image data 122 on the imaging device 102.

The imaging device 102 may generate 214 an event. An event may be data that serves to notify the computing device 132 that an image has been obtained 204 and/or stored 210 on the imaging device 102. The event may be generated 214 using the generated index value 124. Once the event has been generated 214, the imaging device 102 may send 216 the event. For example, the imaging device 102 may send 216 the event to the computing device 132. The imaging device 102 may then return to determine 202 whether to obtain one or more additional images. If the imaging device 102 determines 202 to not obtain one or more additional images, operation may end 218.

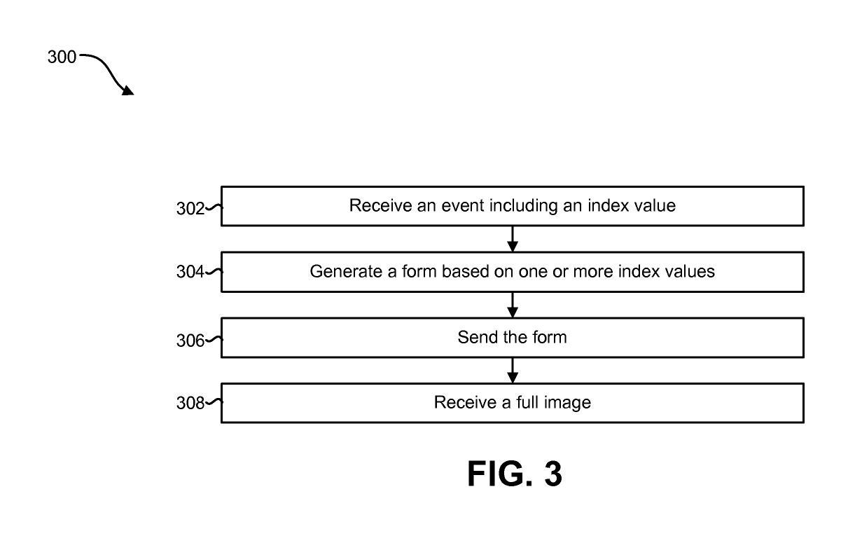

FIG. 3 is a block diagram illustrating one configuration of a method 300 for remotely coordinating imaging device operations. The computing device 132 may receive 302 an event including an index value 124. The index value 124 may indicate where (e.g., an address) full image data 126 and/or thumbnail image data 122 are stored on the imaging device 102 (e.g., in the imaging device memory 120). The computing device 132 may generate 304 a form 136 based on one or more index values 138. For example, the computing device 132 may generate 304 a Hyper Text Markup Language (HTML) form 136 including one or more index values 138. The computing device 132 may send 306 the form 136. In one configuration, the form 136 is sent to the imaging device 102 using the network 130. The computing device 132 may then receive 308 one or more full images 126. For example, the form 136 sent to the imaging device 102 indicates where one or more full images 126 and/or one or more thumbnail images 122 are stored on the imaging device 102. The imaging device 102 uses the form 136 to retrieve and display the thumbnail images 108 on its front panel 104. The thumbnail images 108 may be used for review and/or modification of the full images 126. Once review and/or modifications are complete, the imaging device 102 may send one or more full images 126 corresponding to the thumbnail images 108 to the computing device 132, which may receive 308 and/or store them.

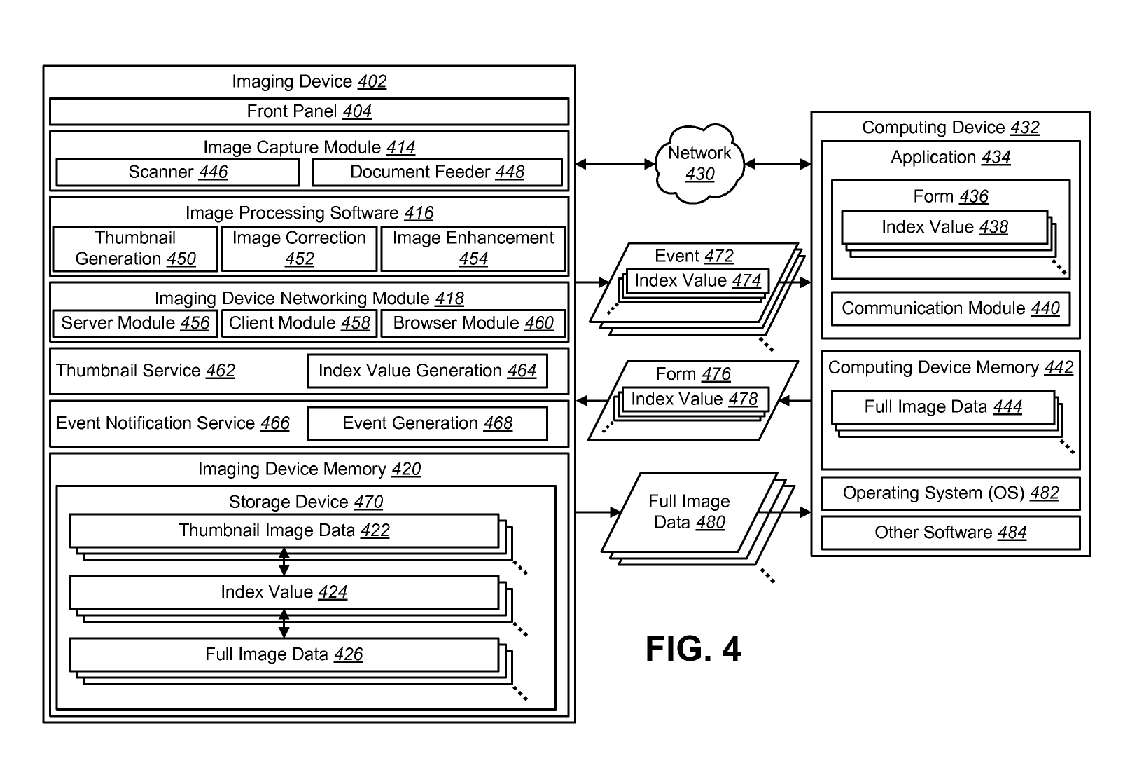

FIG. 4 is a block diagram illustrating a more specific configuration of an imaging device 402 and a computing device 432 wherein systems and methods for providing image information to a remote device may be implemented. The imaging device 402 may be connected to the computing device 432 using a network 430, which may allow the imaging device 402 and the computing device 432 to communicate with each other.

Similar to the description given in connection with FIG. 1, the imaging device 402 may include a front panel 404. Although not shown in FIG. 4, the front panel 404 may include a display 106 and one or more panel command buttons 112. Furthermore, the display 106 may display one or more thumbnail images 108 and provide an interface for one or more display command buttons 110.

The imaging device 402 may also include an image capture module 414, image processing software 416, an imaging device networking module 418, a thumbnail service 462, an event notification service 466 and imaging device memory 420. The image capture module 414 may include a scanner 446 and a document feeder 448. The document feeder 448 may be used to feed documents (e.g., papers) through the scanner 446. The scanner 446 may scan papers or documents, thereby capturing full images 426 of the papers or documents. In other words, the scanner 446 may generate full image data 426 based on one or more scanned documents. The full image data 426 may be stored in the imaging device memory 420.

The image processing software 416 may include functions for thumbnail generation 450, image correction 452 and/or image enhancement 454. For example, when a document is scanned by the scanner 446, thereby capturing a full image 426, the image processing software 416 may generate thumbnail image data 422 based on the full image data 426. As mentioned above, the thumbnail generation 450 module or function may reduce the dimensions and/or resolution of the full image 426 in order to generate a smaller thumbnail image (stored as thumbnail image data 422). More detail on the image correction 452 and image enhancement 454 modules or functions is given below.

The imaging device networking module 418 may be used for the processing of data for transmission using the network 430 or the processing of data received using the network 430. The server module 456 may serve requests received using the network 430. For example, the computing device 432 may send a request to the imaging device 402. The imaging device server module 456 may process the request. The client module 458 may format data for transmission over the network 430. For example, the imaging device 402 may send each scan page done event to the computing device 432 through the client module 458. The browser module 460 may be used to interpret data or messages received from the network 430. For example, the computing device 432 may issue a SHOWSCREEN command to ask the imaging device 402 to browse into a Uniform Resource Locator (URL) (e.g., address) provided by the computing device 432 to display the thumbnails. The browser module 460 may be used to access that URL provided in the SHOWSCREEN command. At the same time, the computing device 432 must construct an HTML form with the thumbnail links extracted from the scan page done event in it. When browser 460 makes the Hypertext Transfer Protocol (HTTP) request to this HTML form page, the computing device 432 will respond to the browser's HTTP request and provide that HTML form page to be displayed on the panel of the imaging device 402.

The thumbnail service 462 may include a function or module for index value generation 464. For example, when full image data 426 is captured by the scanner 446, the thumbnail service 462 may generate an index value 424 corresponding to the full image data 426. The index value 424 may associate thumbnail image data 422 generated by the thumbnail generation module 450 with full image data 426 captured by the image capture module 414.

The event notification service 466 may include an event generation 468 module or function. The event generation 468 module or function may be used to generate an event 472. For example, when full image data 426 has been captured, corresponding thumbnail image data 422 is generated and an index value 424 associating the full image data 426 with the thumbnail image data 422 has been generated, the event generation 468 module or function may generate an event 472, indicating that one or more of these operations has occurred. An event 472 may include one or more index values 474, and may be sent to the computing device 432 using the network 430.

The imaging device memory 420 may include a storage device 470. In one configuration, the storage device is a Hard Disk Drive (HDD). The storage device 470 may include thumbnail image data 422, full image data 426 and one or more index values 424 corresponding to the full image data 426 and/or the thumbnail image data 422.

The computing device 432 may include an application 434, computing device memory 442, an Operating System (OS) 482 and/or other software 484. The OS 482 may be software that provides an environment for computing device 432 operation. Examples of an OS include Microsoft Windows, Linux, Unix, Apple OS X, etc. Other software 484 may be other programs, applications, processes and/or code that allow the computing device 432 to operate properly.

The application 434 may include a communication module 440. The communication module 440 may format data for transmission using the network 430. The application 434 may also generate a form 436. The form 436 may include one or more index values 438. For example, the computing device 432 may receive one or more events 472. The one or more events 472 received may each include one or more index values 474. The application 434 may use the one or more index values 474 received with the one or more events 472 to generate the form 436. For example, the form 436 may be an HTML form 436 including one or more index values 474 received from the imaging device 402.

The computing device 432 may send the form 476 including one or more index values 478 to the imaging device 402. The imaging device 402 may receive the form 476 with its one or more index values 478. The imaging device 402 may parse the form 476 to extract the one or more index values 478. The imaging device 402 may use the one or more index values 478 to retrieve and display thumbnail image data 422 (e.g., representing one or more thumbnail images 108).

The front panel 404 may display the one or more thumbnail images 108 and receive commands to correct and/or enhance the corresponding full images 426. That is, the image correction module 452 may enable corrections to be made to the one or more full images 426. For example, the image correction module 452 may allow adjustments to be made in the contrast of the full image 426. The image enhancement module 454 may also provide functions for enhancing the full images 426. For example, the image enhancement module 454 may include functions such as image rotation, cropping, zoom, annotation, stylized filters (e.g., black and white, sepia, etc.) or other enhancements. The imaging device 402 may receive a confirmation of a review, approval or modifications made to the images via the front panel 404. The imaging device 402 may then send full image data 480 (e.g., one or more full images) to the computing device 432. The computing device 432 may store the received full image data 444 in the computing device memory 442. In this way, transfer of full image data 480 may be postponed until the corresponding full images 426 are ready (e.g., with no other modifications or enhancements to be made). Thus, network 430 traffic may be alleviated by avoiding a transfer of full image data 480 immediately after it is captured (e.g., scanned).

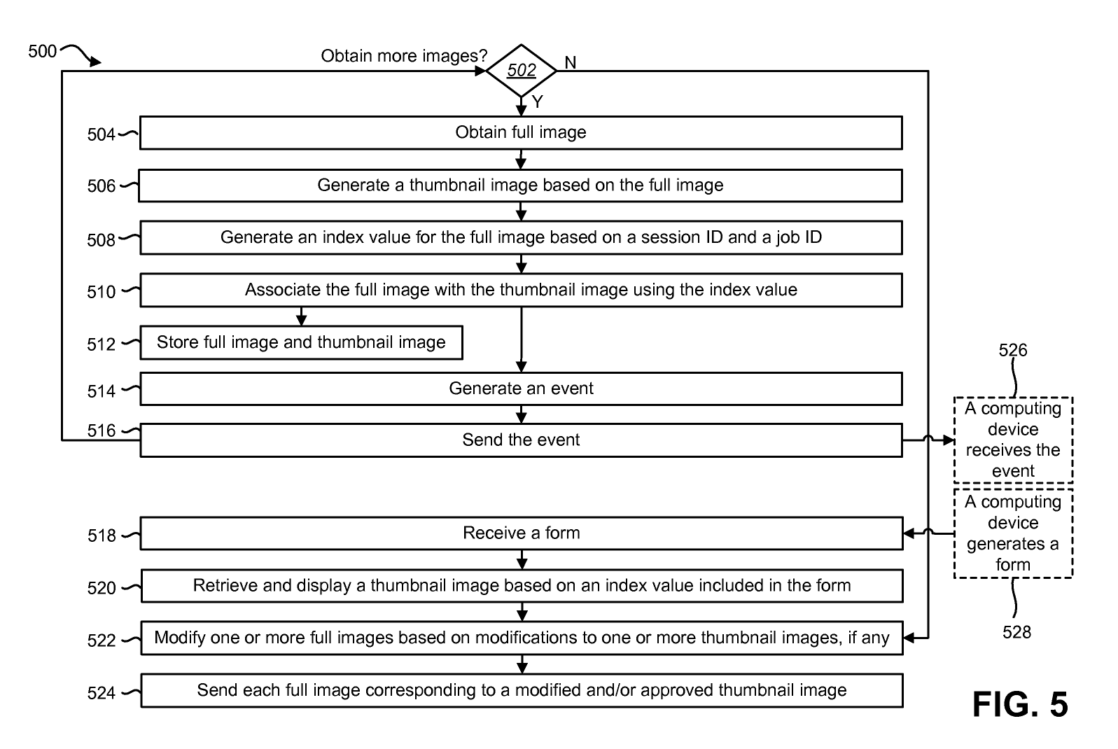

FIG. 5 is a flow diagram illustrating a more specific configuration of a method 500 for providing image information to a remote device. The imaging device 402 may determine 502 whether to obtain one or more images. For example, the imaging device 402 may receive a request to scan a document. Additionally or alternatively, the imaging device 402 may use a sensor to determine if there are more pages to be scanned. If the imaging device 402 determines 502 to obtain one or more additional images, the imaging device 402 may obtain 504 a full image 426. For example, the imaging device 402 may scan a page of a document, thereby obtaining 504 full image data 426. The imaging device 402 may generate 506 a thumbnail image 422 based on the full image 426. For example, the imaging device 402 may compress the full image 426 and/or scale down the full image 426 dimensions to generate 506 the thumbnail image 422. The imaging device 402 may also generate 508 an index value 424 for the full image 426. The index value 424 may indicate one or more addresses where the full image 426 and/or its corresponding thumbnail image 422 may be stored. The imaging device 402 may then associate 510 the full image 426 with the thumbnail image 422 using the index value 424. The imaging device 402 may store 512 the full image 426 and the thumbnail image 422 on the imaging device 402.

The imaging device 402 may generate 514 an event 472. An event 472 may be data that serves to notify the computing device 432 that an image has been obtained 504 and/or stored 512 on the imaging device 402. The event 472 may be generated 514 using the generated index value 424. Once the event 472 has been generated 514, the imaging device 402 may send 516 the event 472 to the computing device 432. The imaging device 402 may return to determine 502 whether to obtain one or more additional images. The event 472 may be received 526 by a computing device 432.

The imaging device 402 may also receive 518 a form 436. The computing device 432 may generate 528 the form as described above. The form 436 may include one or more index values 438. The imaging device 402 may retrieve 520 and display a thumbnail image 408 based on an index value 478 included in the form 476. For example, the index value 478 included in the form 476 may indicate where the thumbnail image data 422 is located in the imaging device memory 420. Thus, the imaging device 402 may use the index value 478 to retrieve the thumbnail image data 422 to display the thumbnail image 408 on the panel of the imaging device 402 through the browser module 460 in the imaging device 402.

The imaging device 402 may modify 522 one or more full images 426 based on modifications to one or more thumbnail images 108, if any. For example, one or more thumbnail images 408 may be displayed on the front panel display 106. The imaging device 402 may provide several functions for image correction and/or image enhancement and/or review. For example, the imaging device 402 may provide image correction 452 functionality such as a contrast modification. The imaging device 402 may also provide image enhancement 454 functionality such as rotation or annotation of an image. Also, the imaging device 402 may display the thumbnail images 408 for user review. A user may direct the imaging device 402 to make these corrections or enhancements using the display command buttons 110 and/or the panel command buttons 112.

The imaging device 402 may receive commands for image correction and/or enhancement. The imaging device 402 may additionally or alternatively simply receive a confirmation of image approval. Thus, the imaging device 402 may thus modify 522 one or more full images 426 based on modifications to one or more thumbnail images 422, if any. The imaging device 402 may send 524 each full image 426 corresponding to a modified and/or approved thumbnail image 422. For example, once all the changes to a full image 426, if any, are made and/or the image is approved (e.g., the imaging device 402 receives an approval input), the imaging device 402 may send 524 each full image 426 corresponding to a modified and/or approved thumbnail image 422. If the imaging device 402 determines 502 to not obtain one or more images, processing may proceed to modification 522 and/or approval of any remaining images. Once all of the captured images are modified and/or approved 522, the remaining image or images may be sent 524 to a computing device 432 for storage.

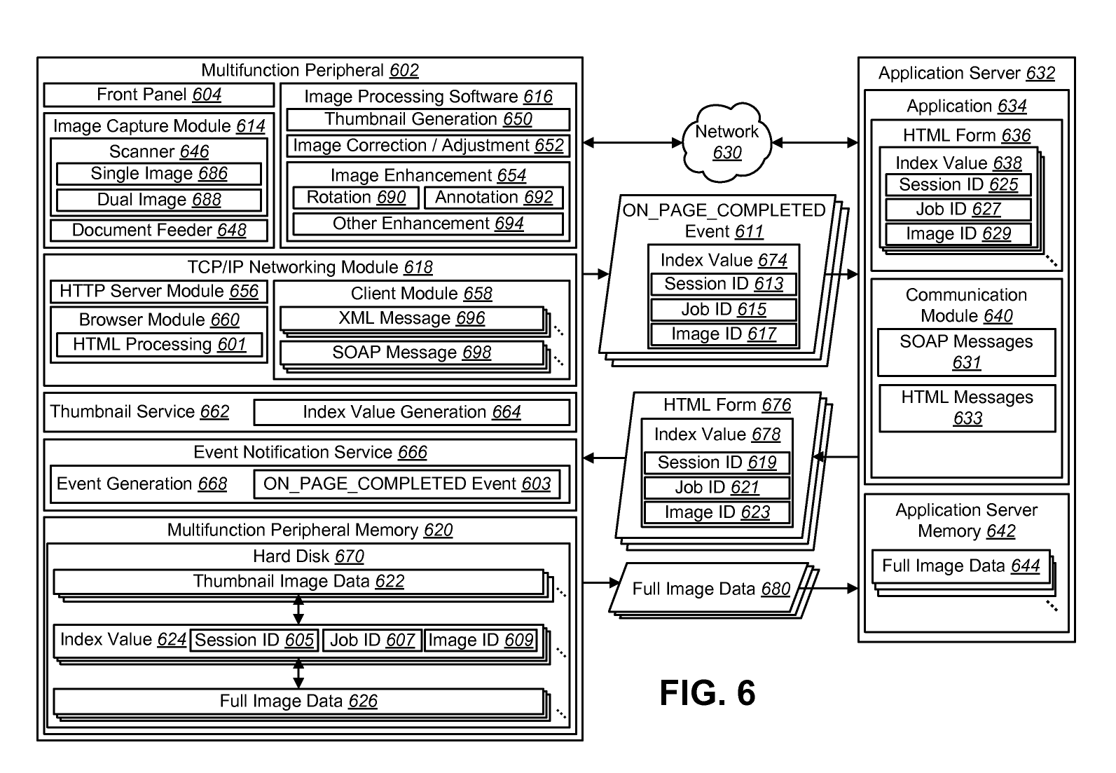

FIG. 6 is a block diagram illustrating one example of one configuration of a multifunction peripheral (MFP) device 602 and an application server 632 in which systems and methods for providing image information to a remote device may be implemented. The MFP 602 may be an electronic device that performs several functions. For example, the MFP 602 may include functions for scanning, printing, faxing and copying. The systems and methods disclosed herein enable an MFP 602 to allow for fast and efficient display and control of thumbnail images 108 by a remote application 634 executing on an external personal computer (PC) or application server 632. The thumbnail images 108 are displayed on the front panel 604 and represent full images 626 scanned by the MFP 602.

The systems and methods disclosed herein may significantly reduce the amount of network 630 traffic required to display a thumbnail representation 108 of each scanned page on the MFP's front panel 604. By storing the full image data 626 on the MFP 602 (e.g., in the MFP device memory 620) and providing to the remote application 634 a “handle” (e.g., index value 624) to access the stored image 626, the remote application 634 may manipulate the page images as if they were stored locally in the application server memory 642. This may be done without the drawback of absorbing bandwidth sending the images back and forth between the MFP 602 and the remote application 634.

The MFP 602 may include a front panel 604. The front panel 604 may include a display 106 and/or one or more panel command buttons 112. The display 106 may display one or more thumbnail images 108 and/or one or more display command buttons 110. The MFP 602 may also include an image capture module 614. The image capture module 614 may include a scanner 646 and a document feeder 648. The document feeder 648 and scanner 646 may be used to scan the pages of a document to create a scanned image, which may be stored as full image data 626. The scanner 646 (with the document feeder 648, for example) may be a single image 686 or dual image 688 scanner.

The MFP 602 may use various operating systems (not shown) to operate. Examples of operating systems that the MFP 602 may use include VxWorks, Linux and Embedded Windows XP, etc. The MFP 602 may also use firmware (not shown) to function properly.

The MFP 602 may include a Transmission Control Protocol/Internet Protocol (TCP/IP) networking module 618. The TCP/IP networking module 618 includes a Hypertext Transfer Protocol (HTTP) server module 656 and a client module 658. The server module 656 may listen to the commands from the application server 632 (i.e., the computing device 432) in a SOAP message format. One example of the SOAP messages received by the server module 656 is a SHOWSCREEN message. This message may invoke the browser module 660 to retrieve the contents in a given URL from the SHOWSCREEN message received by the server module 656. The client module 658 may process Extensible Markup Language (XML) messages 696 and/or Simple Object Access Protocol (SOAP) messages 698. The TCP/IP networking module 618 may also include a web browser module 660 that processes Hypertext Markup Language (HTML) messages 601.

The MFP 602 may also include image processing software 616. The image processing software 616 includes a thumbnail generation function 650 that converts scanned images (stored as full image data 626) to image thumbnails 108 (stored as thumbnail image data 622). The image processing software 616 also provides image correction/adjustment 652 capability and/or image enhancement 654 capability. For example, the image enhancement module 654 may include functions for rotation 690, annotation 692 and/or other enhancement 694 of an image 626.

The MFP 602 includes MFP memory 620. The MFP memory 620 may include a hard disk drive 670, for example. The hard disk drive 670 may store full image data 626 and corresponding thumbnail image data 622.

The application server 632 (e.g., PC application server) on the network 630 may comprise, for example, a PC using one or more operating systems 482. Examples of operating systems that may be used by the application server 632 include Microsoft Windows or Linux. The application server 632 may optionally be a workstation, a portable computer or mainframe system. In addition to the other software necessary for the proper functioning of the application server 632, the application server 632 provides software components (e.g., included in the application 634) to interface with the MFP 602 using SOAP messages 631 and HTML messages 633. The SOAP messages 631 and HTML messages 633 may be included in and/or generated by a communication module 640. These software components may also process and handle scanned images (e.g., full image data 644) from the MFP 602.

In other implementations, an MFP 602 might enable the remote application 634 to display a thumbnail 108 of a scanned image 626 by transmitting full image data 626 to the remote application 634, having the remote application 634 process the full image into a thumbnail suitable for display on the MFP's 602 front panel 604, and then transmitting the thumbnail image back to the MFP 602 for display on the front panel 604. However, that approach uses a significant amount of network 630 bandwidth in moving images (e.g., full image data 626, thumbnail image data 622) to and from the MFP 602, which may not be desirable in certain network environments. Furthermore, that approach may take more time for the thumbnails 108 to be displayed and thus may be less efficient.

However, the systems and methods disclosed herein may be improvements over the other implementations mentioned above. For example, some of the other implementations require the full set of images from the MFP 602 to be transmitted to the remote application 634, where the page images are processed into thumbnails and then sent pack to the MFP 602 for display on the front panel 604. The size of the page images going to the remote application 634 and the return of the smaller thumbnails may generate significant traffic on the network 630, reducing the overall bandwidth more than is necessary with the systems and methods disclosed herein. Furthermore, the systems and methods disclosed herein may decrease the amount of time it takes for the thumbnail image 108 to be displayed on the MFP front panel 604 because the thumbnail image data 622 is stored internally within the MFP 602.

In one configuration, the systems and methods disclosed herein may operate as follows. A scan function or application may be selected at the front panel 604 of the MFP 602. For example, a user may select and initiate the scan function using one or more panel command buttons 112 and/or display command buttons 110. A document may be placed in the document feeder 648. The MFP 602 may scan the pages using the scanner 646 and document feeder 648. While the pages are scanned, thumbnail images 108 representing the scanned images (e.g., stored as full image data 626) may be displayed one by one on the MFP front panel 604. The thumbnail images 108 may be reviewed (e.g., for correctness), modified and/or approved. The full image data 626 may not be transmitted to the external application server 632 until modifications and/or approvals of the thumbnail images 108 are received by the MFP 602.

The systems and methods disclosed herein may enable the remote application 634 to access thumbnail image data 622 stored in the MFP memory 620 as part of a workflow application during and after scanning. The full image data 626 and the thumbnail image data 622 are generated first in the MFP 602. The MFP 602 creates the thumbnail image data 622 based on the full image data 626 (e.g., the scanned images). The thumbnail image data 622 (e.g., the thumbnail images) is stored on the hard disk 670 of the MFP 602. Display of thumbnail images 108 is indexed by the remote application 634 and display of the thumbnail images 108 is performed by the MFP 602.

Each time an image (e.g., page image) is scanned, the MFP 602 provides an ON_PAGE_COMPLETED event 611 to the remote application 634. The ON_PAGE_COMPLETED event 611 sent to the remote application 634 includes a unique image index value 674 for each page scanned and/or image formed. This image index value 674 may then be used by the application 634 to reference the full image data 626 and/or thumbnail image data 622. The image index value 638 may be used in an HTML form 636 to display the thumbnail image 622 and/or full image data 626. The MFP 602 recognizes the image index value 678 as belonging to an image (e.g., full image data 626 and/or thumbnail image data 622) in the MFP's 602 image store (in MFP memory 620). Instead of retrieving the image (e.g., full image data 626 and/or thumbnail image data 622) from the remote application 634, it retrieves the image from its internal image store (e.g., in MFP memory 620). The following XML example in Listing (1) shows how the remote application 634 may be notified with the index value 674 through a SOAP ON_PAGE_COMPLETED event 611 message.

Listing (1)

<Event>

<event-data>

<details xsi:type=”DETAILS_ON_PAGE_COMPLETED_TYPE”>

<img-id uid=”SN12345678UI12345_JB98765_IMG001”>

<img-name>SN12345678UI12345_JB98765_IMG001.jpg</img-name>

</img-id>

</details>

</event-data>

</Event>

A thumbnail web service 662 on the MFP 602 provides an index value generation 664 module. An event notification web service 666 includes an event generation 668 module. In other words, the event notification service 666 generates the ON_PAGE_COMPLETED events 611. These web services 662, 666 provide an interface between the MFP 602 and the remote application 634.

The image index value 624, 674, 638, 678 may be of the form UISessionID:JobID:ImageID. UISessionID 605, 613, 625, 619 is a unique identifier granting exclusive front panel access to an application 634. JobID 607, 615, 627, 621 is a unique identifier for a job executing in the MFP 602. ImageID 609, 617, 629, 623 is a unique identifier for each image (e.g., full image data 626 and/or thumbnail image data 622) in a job. One example of an image index value 624, 674, 638, 678 is SN12345678UI12345_JB98765_IMG001.jpg.

The image index value 638 may be used to generate an HTML form 636. The HTML form 676 (sent to the MFP 602) may be used to display the thumbnail image 108. The MFP 602 recognizes the image index value 678 as belonging to an image (e.g., full image data 626 and/or thumbnail image data 622) in its 602 image store (e.g., in MFP memory 620). Instead of retrieving the image from the remote application 634, it retrieves the image from its 602 internal image store (e.g., in MFP memory 620). The HTML form 636 data generated by the external application 634 may be in response to an HTTP GET request by the MFP 602. Listing (2) shows one example of HTML form 676 data to display the thumbnail image 108 on the MFP front panel 604.

Listing (2)

<!DOCTYPE html PUBLIC “-//W3C//DTD XHTML 1.0
Transitional//EN”
“http://www.w3.org/TR/xhtml1/DTD/xhtml1-transitional.dtd”>

| | |
|---|---|
| <!-- This sample shows how internal thumbnails can be displayed | --> |
| <!-- by an external server | --> |

<html xmlns=”http://www.w3.org/1999/xhtml” >
<head>

<meta name=”Browser” content=”NetFront” />
<title>Display A Thumbnail loaded from HDD</title>

</head>
<body>

<img
src=”hdd://hdd_path/SN12345678UI12345_JB12345_IMG001.jpg”

width=”W” height=”H” />
</body>

In the HTML example above (Listing (2)), the <img/> tag is: <img src=“hdd://hdd_path/SN12345678UI12345_JB12345_IMG001.jpg” width=“W” height=“H” />. The “src” is in the form of a Uniform Resource Locator (URL). The protocol header, “hdd”, plus the path of the thumbnail file references the MFP 602 internally generated thumbnail image 622. This protocol header indicates that the referenced object will be accessed from the hard disk drive (HDD) 670. The thumbnail reference name “hdd://hdd_path/SN12345678UI12345_JB12345_IMG001.jpg” is generated by the thumbnail service 662 within the MFP 602 and is used by an HDD Application Programming Interface (API) to retrieve the thumbnail image data 622 stored in the HDD 670. The MFP 602 may use the thumbnail image data 622 to display a thumbnail image 108 on the front panel 604. Once an image (e.g., thumbnail image data 622 and/or full image data 626) is approved and/or modified, corresponding full image data 680 may be sent to the application server 632. The application server 632 may receive and store the full image data 644 in application server memory 642.

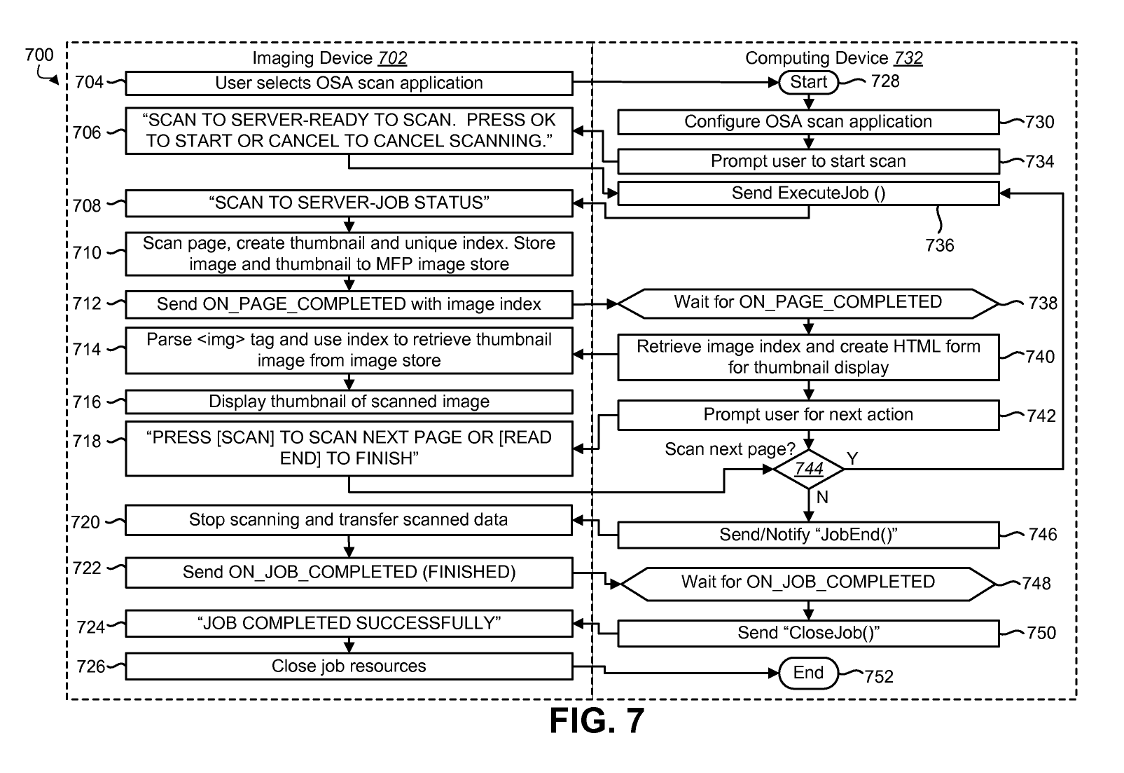

FIG. 7 is a flow diagram illustrating one configuration of a method 700 for providing image information to a remote device. The flow diagram in FIG. 7 also indicates where each operation may be performed. Generally, operations included in the imaging device 702 block may be performed on or at the imaging device 702, while operations performed in the computing device 732 block may be performed on or at the computing device 732.

A scan application may be selected 704 at the imaging device 702. For example, a user may select an Open Systems Architecture (OSA) scan application at the front panel 104 of the imaging device 702. A start message may be sent to the computing device 732 indicating a start 728 to scanning application operation. The computing device 732 may configure 730 (e.g., initialize) the OSA scan application 134. The computing device 732 may then prompt 734 a user to start a scan. For example, the computing device 732 may send a message to the imaging device 702 that is displayed 706 on the front panel 104 display 106. In the example illustrated in FIG. 7, the message displayed 706 on the front panel 104 of the imaging device 702 is “SCAN TO SERVER—READY TO SCAN. PRESS OK TO START OR CANCEL TO CANCEL SCANNING.” The imaging device 702 may receive a command (e.g., from a user) to start scanning or cancel scanning. This command may be received via the panel command buttons 112 and/or the display command buttons 110.

If a command is received to proceed with scanning, the imaging device 702 may send a message to the computing device 732 indicating that scanning should be commenced. The computing device 732 may send 736 an “ExecuteJob( )” message or function call to the imaging device 702. Additionally, the computing device 732 may send job status messages to be displayed 708 on the imaging device 702. Alternatively, data indicating a particular status message to be displayed 708 may be sent to the imaging device 702 from the computing device 732. For example, the message “SCAN TO SERVER—JOB STATUS” may be sent and/or displayed 708.

The imaging device 702 may scan 710 a page, create 710 thumbnail image data 122 based on the full image data 126 and create 710 a unique index value 124 corresponding to the full image data 126 and/or the thumbnail image data 122. The imaging device 702 may also store 710 the full image data 126 and the thumbnail image data 122 to the MFP 702 image store (e.g., in the imaging device memory 120). The imaging device 702 may then generate and send 712 an ON_PAGE_COMPLETED event 611 with the image index value 124.

The computing device 732 may be waiting 738 to receive an ON_PAGE_COMPLETED event 611. When the computing device 732 receives the ON_PAGE_COMPLETED event 611, it may proceed to retrieve 740 the image index value 124 from the event 611 and create 740 an HTML form 636 for thumbnail image 108 display. The computing device 732 may send the HTML form 676 to the imaging device 702. The imaging device 702 may parse 714 the <img> tag and use the index value 678 to retrieve 714 thumbnail image data 122 from the image store (e.g., in the imaging device memory 120). This may be accomplished, for example, by the HTML processing module 601 included in the imaging device 702. The imaging device 702 may then display 716 the thumbnail image 108 of the full image 126 on the front panel 104 display 106.

The computing device 732 may prompt 742 a user for the next action. For example, the computing device 732 may send a message or data that indicates a message to be displayed to the imaging device 702. In this example, the imaging device 702 may display 718 a message “PRESS [SCAN] TO SCAN NEXT PAGE OR [READ END] TO FINISH.” The imaging device 702 may then receive a command from one or more command buttons 110, 112 and send a corresponding message to the computing device 732. The computing device 732 may then determine 744 whether to scan an additional page or image. This determination 744 may be made based on the message received from the imaging device 702 that indicates whether to scan another page or finish.

If the computing device 732 determines 744 to scan the next page, operation may return to sending 736 an “ExecuteJob( )” message. If the computing device 732 determines 744 not to scan another page, the computing device 732 may send 746 (or notify the imaging device 702 using) a “JobEnd( )” message or function call to the imaging device 702.

The imaging device 702 may stop scanning 720 and transfer scanned data (e.g., full image data 126) to the computing device 732, which may store the full image data 144 in computing device memory 142. The imaging device 702 may send 722 an ON_JOB_COMPLETED (FINISHED) event or message to the computing device 732. The computing device 732 may be waiting 748 for an ON_JOB_COMPLETED event 611 or message from the imaging device 702. The computing device 732 may send 750 a “CloseJob( )” message or function call to the imaging device 702. The computing device 732 may additionally or alternatively send a message or data indicating a message to be displayed 724 on the imaging device 702. The imaging device 702 may display 724 a message. In this example, the imaging device 702 may display 724 a “JOB COMPLETED SUCCESSFULLY” message on the front panel 104 display 106. The imaging device 702 may then close 726 job resources and operation may end 752.

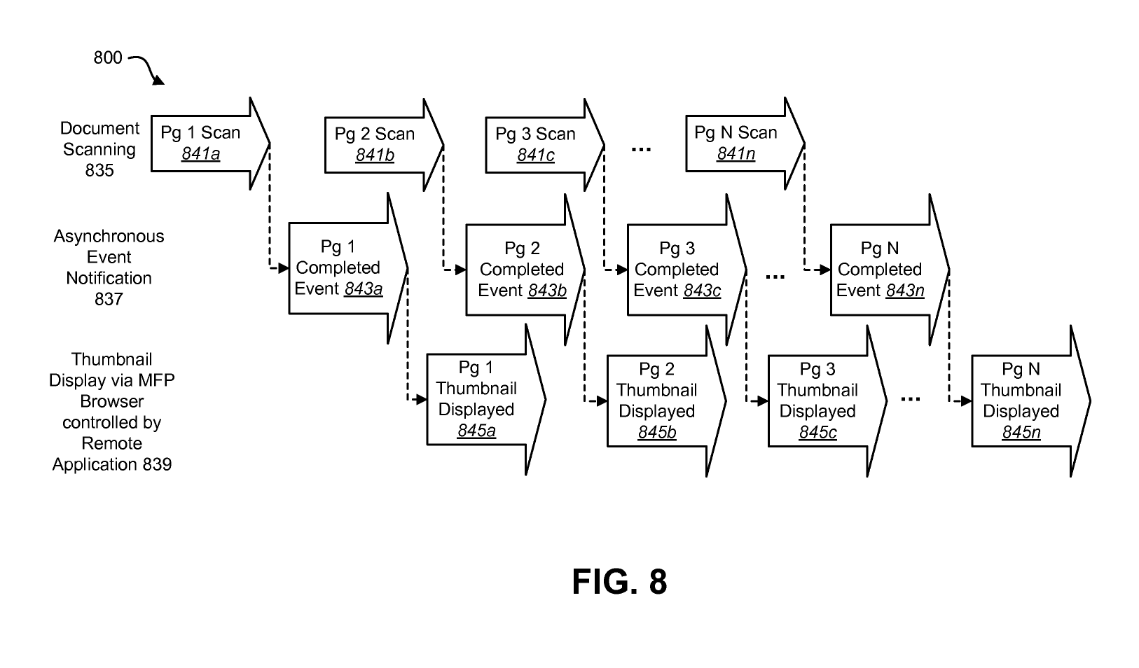

FIG. 8 is a diagram illustrating pipelined operation 800 for the systems and methods disclosed herein. In other words, according to the systems and methods disclosed herein, thumbnail image 108 displays may be pipelined or batched. Pipelined operation 800 may provide closer to real-time display of the thumbnail images 108.

The first row of arrows illustrated in FIG. 8 indicates document scanning 835 operations over time. The second row of arrows indicates asynchronous event notification 837 operations over time. The third row of arrows indicates display 839 of thumbnail images 108 via the MFP 602 browser 660 controlled by the remote application 634. Generally, the operations illustrated in FIG. 8 may be performed on an imaging device 102.

For example, a first page may be scanned 841a, upon which the imaging device 102 may send 843a an event indicating a completed scan (e.g., an ON_PAGE_COMPLETED event 611). The imaging device 102 may then display 845a a thumbnail image 108 on the front panel 104 display 106. For example, the imaging device 102 may receive an HTML form 676 indicating one or more thumbnail images 108 to display. As illustrated by FIG. 8, for example, the second page scan 841b may occur while the first page's completed event 843a is being sent 843a. Furthermore, the third page scan 841c may occur during the second page completed event notification 843b and during the display 845a of the first thumbnail image 108. Operation may continue in a similar manner for each of the pages scanned 841a-n, each completed event notification 843a-n and display 845a-n of each thumbnail image 108. Alternatively, these operations may be batched. For example, a group of pages may be scanned 835, followed by sending 837 a group of notifications and then followed by display 839 of a batch of thumbnail images 108.

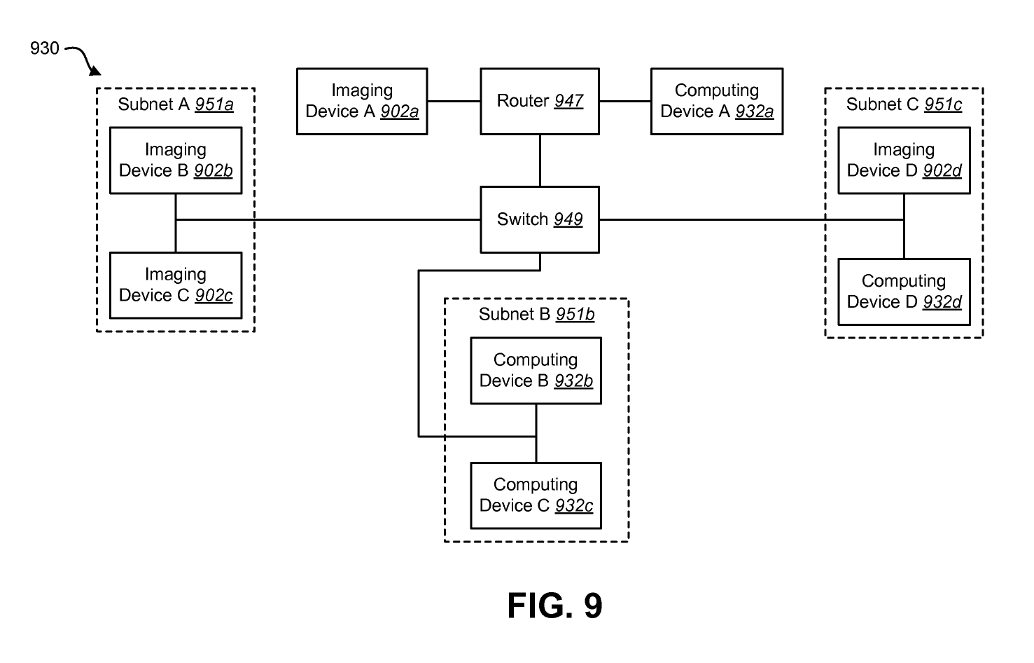

FIG. 9 is a block diagram illustrating several configurations of a network 930 in which systems and methods for providing image information to a remote device may be implemented. In one configuration, imaging device A 902a may be connected to computing device A 932a using a router 947. Alternatively, imaging device A 902a may be connected to computing device B 932b on subnet B 951b using a router 947 and a switch 949. In another configuration, imaging device B 902b may be included in subnet A 951a and may be connected to computing device A 932a using a switch 949 and a router 947. Alternatively, imaging device B 902b on subnet A 951a may be connected to computing device B 932b on subnet B 951b using a switch 949. In yet another configuration, imaging device D 902d may be connected to computing device D 932d on (the same) subnet C 951c using a switch 949.

As illustrated by FIG. 9, subnet A 951a may include only imaging devices 902b-c. Subnet B 951b may include only computing devices 932b-c. Or, subnet C 951c may include one or more imaging devices 902d and one or more computing devices 932d. Although only one router 947, one switch 949, three subnets 951a-c, four imaging devices 902a-d and four computing devices 932a-d are illustrated in FIG. 9, any number of routers 947, switches 949, subnets 951, imaging devices 902 and computing devices 932 may be used in accordance with the systems and methods disclosed herein.

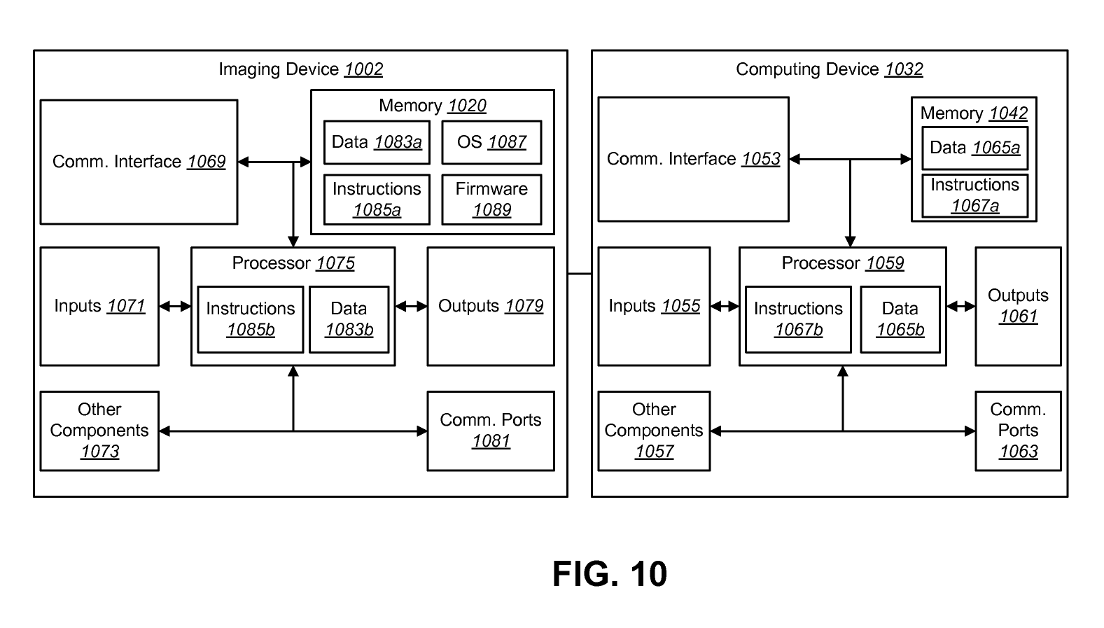

FIG. 10 is a block diagram illustrating hardware components that may be used in accordance with the systems and methods disclosed herein. The systems and methods disclosed may be implemented and used with a computing device 1032 and an imaging device 1002 (e.g., MFP). The hardware components typically utilized in a computing device 1032 are illustrated in FIG. 10. A computing device 1032 may include a processor 1059 (e.g., Central Processing Unit (CPU)) in electronic communication with input components or devices 1055 and/or output components or devices 1061. The processor 1059 is operably connected to input 1055 and/or output devices 1061 capable of electronic communication with the processor 1059, or, in other words, to devices capable of input and/or output in the form of an electrical signal. Some configurations of computing devices 1032 may include the inputs 1055, outputs 1061 and the processor 1059 within the same physical structure or in separate housings or structures.

The computing device 1032 may also include memory 1042. Memory 1042, which may include both read-only memory (ROM), random access memory (RAM) or any type of device that may store information, provides instructions 1067a and data 1065a to the processor 1059. A portion of the memory 1042 may also include non-volatile random access memory (NVRAM). The memory 1042 may be a separate component from the processor 1059, or it may be on-board memory 1042 included in the same part as the processor 1059. For example, microcontrollers often include a certain amount of on-board memory. Memory 1042 may store data 1065a and instructions 1067a. The data 1065a and/or instructions 1067a may be used by the computing device to perform the methods disclosed herein. That is, the processor 1059 may use data 1065a and or instructions 1067a stored in memory 1042 to perform the methods disclosed herein. Furthermore, data 1065b and/or instructions 1067b may also be loaded onto the processor 1059.

The processor 1059 is also in electronic communication with a communication interface 1053. The communication interface 1053 may be used for communications with other computing devices 1032, imaging devices 1002, servers, etc. Thus, the communication interfaces 1053 of the various computing devices 1032 may be designed to communicate with each other to send signals or messages between the computing devices 1032.

The computing device 1032 may also include other communication ports 1063. In addition, other components 1057 may also be included in the computing device 1032.

Many kinds of different devices may be used with configurations of the systems and methods disclosed herein. The computing device 1032 may be a one-chip computer, such as a microcontroller, a one-board type of computer, such as a controller, a typical desktop computer, a Personal Digital Assistant (PDA), a Unix-based workstation, etc. Accordingly, the block diagram of FIG. 10 is only meant to illustrate typical components of a computing device 1032 and is not meant to limit the scope of the systems and methods disclosed herein.

The computing device 1032 is in electronic communication with the imaging device 1002 (e.g., MFP). An imaging device 1002 is a device that receives or transmits an imaging job, such as a Multi-Function Peripheral (“MFP”) or computing device. Imaging devices 1002 include, but are not limited to, physical printers, multi-functional peripherals, a printer pool, a printer cluster, a fax machine, a plotter, a scanner, a copier, a logical device, a computer monitor, a file, an electronic whiteboard, a document server, etc. A typical printing device, such as a physical printer, fax machine, scanner, multi-functional peripheral or copier is a type of computing device. As a result, an imaging device 1002 also includes a processor 1075, memory 1020, communications interface 1069, inputs 1071, outputs 1079, communication ports 1081 and/or other components 1073 as similarly described in relation to the computing device 1032. The imaging device 1002 memory 1020 may also include data 1083a and instructions 1085a. The data 1083b and instructions 1085b may be loaded onto the processor 1075. The imaging device 1002 memory 1020 may also include an operating system 1087 and firmware 1089. Examples of an operating system that may be used on an imaging device 1002 include VxWorks, Linux, or Embedded Windows XP, etc. The firmware 1089 may comprise data and or instructions used for the proper operation of the imaging device 1002. The imaging device 1002 may be a single or a plural grouping (e.g., pool or cluster) of two or more devices.

The term “computer-readable medium” or “processor-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, a processor-readable medium may similarly comprise RAM, ROM, EEPROM, CD-ROM or other optical disk storage, magnetic disk storage or other magnetic storage devices, or any other medium that can be used to carry or store desired program code in the form of instructions or data structures and that can be accessed by a processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Each of the methods disclosed herein comprises one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. An imaging device configured to provide image information to a remote device, comprising:
a processor;
memory in electronic communication with the processor;
instructions stored in the memory, the instructions being executable to:
obtain a full image;
generate, on an imaging device, a thumbnail image based on the full image;
associate the full image with the thumbnail image using an index value; and
store the full image and the thumbnail image on the imaging device.

2. The imaging device of claim 1, further comprising a scanner.

3. The imaging device of claim 1, wherein obtaining a full image comprises scanning.

4. The imaging device of claim 1, wherein the instructions are further executable to send the full image only after receiving an approval.

5. The imaging device of claim 1, wherein the instructions are further executable to send the full image only once after receiving an approval.

6. The imaging device of claim 1, wherein the instructions are further executable to send the index value.

7. The imaging device of claim 6, wherein the index value is sent without the full image and without the thumbnail image.

8. The imaging device of claim 1, wherein the instructions are further executable to:
generate an event based on the index value;
send the event;
receive a form including the index value;
retrieve the thumbnail image using the index value; and
display the thumbnail image.

9. The imaging device of claim 1, wherein the instructions are further executable to modify the full image while the thumbnail image is being displayed.

10. The imaging device of claim 8, wherein the imaging device operates according to a selection from the group consisting of: pipelined operations and batched operations.

11. A computing device configured for remotely coordinating image device operations, comprising:
a processor;
memory in electronic communication with the processor;
instructions stored in the memory, the instructions being executable to:
receive an event including an index value;
generate a form based on the index value;
send the form; and
receive a full image.

12. The computing device of claim 11, wherein the instructions are further executable to store the full image.

13. The computing device of claim 11, wherein the form is used by an imaging device to display one or more thumbnail images.

14. A method to provide image information to a remote device, comprising:
obtaining a full image;
generating, on an imaging device, a thumbnail image based on the full image;
associating, on the imaging device, the full image with the thumbnail image using an index value; and
storing the full image and the thumbnail image.

15. The method of claim 14, wherein a scanner is used to obtain the full image.

16. The method of claim 14, wherein obtaining the full image comprises scanning.

17. The method of claim 14, further comprising sending, from the imaging device, the full image only after receiving an approval.

18. The method of claim 14, further comprising sending, from the imaging device, the full image only once after receiving an approval.

19. The method of claim 14, further comprising sending, from the imaging device, the index value.

20. The method of claim 19, wherein the index value is sent without the full image and without the thumbnail image.

21. The method of claim 14, further comprising:
generating an event based on the index value;
sending the event from the imaging device;
receiving a form including the index value;
retrieving the thumbnail image using the index value; and
displaying the thumbnail image.

22. The method of claim 14, further comprising modifying, the full image while the thumbnail image is being displayed.

23. The method of claim 21, wherein the method operates according to a selection of the group consisting of: pipelined operations and batched operations.

24. A method for remotely coordinating image device operations, comprising:
receiving an event including an index value;
generating, on a computing device, a form based on the index value;
sending the form from the computing device; and
receiving a full image.

25. The method of claim 24, further comprising storing the full image.

26. The method of claim 24, wherein the form is used by an imaging device to display one or more thumbnail images.

27. A non-transitory tangible computer-readable medium for providing image information to a remote device comprising executable instructions for:
obtaining a full image;
generating a thumbnail image based on the full image;
associating the full image with the thumbnail image using an index value; and
storing the full image and the thumbnail image.

28. A non-transitory tangible computer-readable medium for remotely coordinating image device operations comprising executable instructions for:
receiving an event including an index value;
generating a form based on the index value;
sending the form; and
receiving a full image.
